(19) United States
(12) Patent Application Publication
(10) Pub. No.: US 2014/0184207 A1
(43) Pub. Date: Jul. 3, 2014

(54) System for Capturing the Position of an Object

(71) Applicants: Johannes Rosenmoeller, Muenster (DE); Juergen Loeschinger, Tuebingen (DE); Richard Feichtinger, Tuebingen (DE)

(72) Inventors: Johannes Rosenmoeller, Muenster (DE); Juergen Loeschinger, Tuebingen (DE); Richard Feichtinger, Tuebingen (DE)

(21) Appl. No.: 14/124,883

(22) PCT Filed: May 30, 2012
(86) PCT No.: PCT/DE2012/100160

§ 371 Date: Feb. 28, 2014

(30) Foreign Application Priority Data
Jun. 8, 2011 (DE) 10 2011 050 926.7

(51) Int. Cl. G01B 7/00

(52) U.S. Cl. CPC G01B 7/003
USPC 324/207.22

(57) ABSTRACT

A system for capturing the position of a moving object, using a marker that is a passive component, and a sensor that is an active component. The sensor is carried or attached to the moving object and the marker placed at a stationary location. When the distance between the sensor and the marker is less than the detection range of the sensor, the sensor automatically detects the presence of the marker and produces a detection signal. The sensor has an electronic circuit of the sensor with a clock device and a storage unit, so that the time the signal is generated is automatically stored.

### BACKGROUND INFORMATION

### Field of Invention

The invention relates to a system for capturing the position of an object.

Conventional systems for capturing the position of an object are, for example, with so-called RFID systems are known. In such systems, a spatially fixed sensor is provided, that has a power source and by sending out electro-magnetic waves excites the marker to send out electro-magnetic waves, whereby the marker sends out waves with its individual coding. The sensor has, in addition to the sender, also a receiver, with which it can receive data send from the marker. Such a system is used, for example, as so-called path block in the field of automobile technology. The sensor is the component that is designated the spatially fixed component, i.e., is provided within the vehicle, and the marker is the movable component and is incorporated into the vehicle key, which the operator of the vehicle carries on his or er person. Access rights for locks on buildings are similarly constructed, and in those cases, the sensor can be considered to be actually spatially fixed.

The marker has to be located in a capture area in the so-called close field range, i.e, within a range of several millimeters or centimeters, to be able to trigger a signal on the sensor.

The same applies to the construction of systems for position recognition, as are frequently used in the industry and which use magnets as markers. The magnets are affixed to the objects and, as soon as the object with the magnet reaches the capture range of a magnetic sensor, for example, the capture range of a reed switch, Hall sensor, etc., a corresponding sensor signal is generated by the magnetic sensor, so that, for example, electrical devices down the line can be switched on or off. With these applications, too, of the combination of magnetic marker and magnetic sensor, the capture range is limited to a close range of just a few millimeters or centimeters, so that the two components, marker and sensor, have to be positioned relative each other rather exactly for a reliable position capture and because of that, an adjustment of the two elements is necessary.

The position capture of an object is, however, not only of importance in industrial applications, but also, for example, at sporting events. For example, the performance of an athlete can be evaluated or a clear statement can be made as to athlete sequence at competitions. For example, sequence of athletes crossing a finish line at running competitions cannot be automatically recorded in practice by sensory detection, because that type of detection is limited to close range use.

For this reason, light barriers are conventionally used, whereby the sensors are spatially fixed in the barriers and a power source can be provided. Any type of a marker can be used that is capable of interrupting the light beam that is emitted and detected by the barrier. The marker can be the athlete him- or herself, whereby it is a problem if the athletes are running very close to each other and run through the barrier at the finish line at the same time. In such cases, additional means of evaluating the results are needed, in order to determine who crossed the finish line first. For that reason, typically an evaluation using additional optical means is necessary, in order to make a call as to the sequence of the runners crossing the finish line with the expected reliability.

With light barrier systems that are not permanently installed, but are set up on a temporary basis, it can be difficult to set it up so that the sender and receiver of the light barrier are sufficiently stable. Oscillations caused by vibration on the floor, by wind, etc., of one or the other of these two components can have the effect, that the light beam does not hit the receiver, so that it is possible that the presence of a marker is indicated, although in actuality no marker has interrupted the symbolic finish line represented by the light barrier. Such oscillations of the light barrier components is particularly a problem when the athletes approach the light barrier and can cause the floor to vibrate enough to cause such oscillations.

On the other hand, with permanently installed light barriers, it can be problematic to provide a permanently installed power source for the sensor, because this requires that power cables and data cables be laid and connected to the light barrier.

U.S. Pat. No. 6,917,565 B2 discloses a conventional system for recording the position of an object. The system includes spatially fixed markers, as well as movable sensors. In order to use the system at sports events, whereby, for example, a runner carries the sensor and runs past the marker at a distance of several decimeters, the magnetic marker has to have a sufficiently large range. In order to achieve this, the marker comprises many individual magnets that are oriented in the same direction and are arranged parallel to each other, and thereby achieve the sufficiently large magnetic strength.

### BRIEF SUMMARY OF THE INVENTION

The object of the invention is to improve a conventional system such, that the system can be set up at any place, quickly and for a short period of time, without requiring a power supply or a data connection to the spatially fixed components installed in the system and that the system is able to record multiple objects simultaneously.

The invention proposes in other words, to construct the marker as a magnetic dipole, whereby the corresponding sensor is constructed as a magnetic sensor. This makes it possible to construct an economic embodiment of the system, because the magnets and the magnetic sensors are commercially available and cost-effective. For example, magnetic sensors may be used, such as are used in compasses, whereby the magnetic sensors in these applications detect the magnetic field of the earth.

The magnetic field depends on the length of the dipole, and the magnetic field diminishes according to the third potential of the distance to the dipole. According to the invention, the detection range is increased by extending the length of dipole of the magnet. A so-called close range with regard to the range for the marker can be defined, for example, as a distance on the order of the size of approximately the length of the dipole. The detection or capture range according to the invention has been increased to a so-called wide range, that is at least twice the length, and preferably, four times the length, and up to ten time or more of the length of the dipole. This is achieved by constructing the marker as a yoke designated an extension yoke for extending and focusing the magnetic field lines. The yoke is made of a ferromagnetic material with high magnetic permeability (μr) and is several centimeters long. At least one magnet is provided on each end of this extension yoke, such, that an extended magnetic total dipole is created, the length of which is the sum of the individual magnets and the extension yoke. This arrangement is designated in the description that follows as a magnetic compound dipole (MCD). With this MCD, the area that can be covered is wide range, from a decimeter to the meter range.

The magnets are, thus, not aligned in parallel to each other, but rather, in rows, so that their magnetic north-south axis extends in the longitudinal direction of the extension yoke and the two magnets extend the length of the extension yoke. The magnets are hereby aligned in the same direction. If, for example, the dipole is constructed as a vertically aligned bar, then the north pole of ach of both magnets point either upward or downward. In an extreme case, the extension yoke itself can be made upof a series of identically aligned individual magnets that are also aligned in the vertical orientation. In practice, however, it is more cost-effective to make the extension yoke out of a soft iron bar and to dock both of its ends 1, 2, or three individual magnets, arranged in the same vertical orientation.

In one embodiment, the MCD is made of two permanent magnets having a diameter of 2.0 cm and a thickness of 1 cm, which are separated from each other by an iron bar with low carbon content of the same diameter and having a length of 25 cm, 50 cm, 1 m, or more. Instead of round, the cross-sections of the magnets and the iron bar may be polygonal or have a different shape. The ends of the iron bar are ground flat, so that there is a good surface connection between bar and magnet.

The MCD is not provided as an accessible component, in order to avoid that close range with the MCD and its strong magnetic field has undesired consequences on objects and persons. So, the MCD is molded or incorporated into a different material.

In one embodiment, the MCD is surrounded by a plastic foam material. The field accessible from outside has a strength, that a paper clip lying beneath the MCD cannot of itself overcome the force of gravity and move toward the MCD. The accessible magnetic field strengths are in the same dimension as those of small loud speakers, for example, those in mobile phones.

The length extension of the dipole enables an inexpensive and significant increase in the magnetic range, so much so, that the detection range becomes so wide, that it can, for example, be used for sporting events or for the monitoring of the movement of animals, for example, when the object to be monitored has to pass through a gate or barrier, and the gates or barriers are designed to be within the detection or capture range of the system according to the invention.

Advantageously, the iron bar mentioned above may have a magnet at each end, whereby these magnets are mounted in such a way that iron bar and magnets form a magnetic dipole (MCD). An iron bar 25 cm in length provides in practice a useful and large magnetic field that can be readily detected by commercially available magnetic sensors. As a result, the corresponding detection signal is reliably detected by the sensor or its electronics.

A typical application, although provided here purely as an example, will be used repeatedly hereinafter, and that is the example of the use of a system to capture the athletes running across the finish line at a foot race. It is understood, that the sensors may also be provided on animals, for example, race horses, or on inanimate objects, for example, for sporting or racing events, on race cars or on objects that athletes carry or throw, or on carts that are drawn by animals, etc. The system is, of course, not limited to sporting events, but may also be used in completely different applications , as will be explained below.

Advantageously, the system according to the invention allows the use of multiple sensors, each of which is provided on a different object. Thus, each runner in a group of runners may carry his or here own sensor.

The system according to the invention also provides the possibility of providing the electronic circuit for the sensor with a time element, so that the time the capture or detection signal is generated is automatically stored. If each athlete in a group of athletes has been allocated an individually specific sensor, and the athletes then run past a marker, each sensor of each athlete registers the distance to the marker, so that the sensor generates the detection signal. The detection signal is generated at a very specific time, evaluated, and subsequently stored. The data from all sensors may be evaluated at a later time and, based on the sensor evaluation, it is possible to very precisely determine, which athlete passed the marker at which time.

In one embodiment, the captured times may be wirelessly transmitted directly from the sensors and displayed on a display board or scoreboard or may be used elsewhere.

The quartz-controlled clocks of commercially available sensors have a clock precision that doesn't deviate in a significant way from the actual times of the time periods at interest here, for example, several minutes for 100 m run or several hours for a marathon race or an automobile sporting event and, therefore, an evaluation of the sensor data will have the necessary precision.

It is initially unimportant whether the clocks of several sensors display a different absolute time, i.e., if they deviate from the actual local time, because when the signals are evaluated, these differences in absolute time can be compared with each other and eliminated by applying appropriate correction factors, to then obtain comparable relative times that can be the basis for calculating, for example, the time from start to crossing the finish line. As an alternative to using correction factors, the sensor clocks can be “reset” at the beginning of the sporting event so that they all have a common value, either the actual local time or simple a zero value. The events captured by the sensors will then have directly comparable values.

It may be advantageous, that not only one marker is allocated to the system to register, for example, passing a finish line or goal line, but rather, that multiple markers are used. These markers are spaced far enough apart, so that their detection ranges don't overlap with each other. It is understood, that the size of the detection range of each sensor is determined by the sensitivity of the sensor that corresponds to the same system.

With regard to sporting events, the markers that are spaced apart from each other may be set up along a course that the athletes have to run, so that, between the start and the finish line, intermediate times are able to be recorded. For example, in a hurdle race, markers may be placed at the individual hurdles. For training purposes, the performance capability of an athlete may be analyzed by evaluating the intermediate times, for example, to find out if there is an undesirable drop in performance on certain stretches of the race course.

With regard to applications other than recording times in sports, separate markers, spaced apart, may be used to record certain activities. For example, the markers may be placed within a certain area in order to determine how many, when, and at which point, do the objects of interest pass through a certain point or gate. The sensors may be placed on horses in stalls, for example, and, based on the magnetic barriers that are distributed throughout the area, one may determine just where the horse is at any given time.

Instead of use at gates or passages, multiple markers may be set up so that their detection ranges do overlap each other. In this way, a specific area may be fenced in with invisible fences, for example. In this case, the MCDs are set up along a line. When the horse approaches one of the MCDs, a signal may be generated that influences the horses behavior and thereby prevents it from crossing over the invisible boundary.

In another embodiment, the effective direction of the MCDs may be achieved by creating a wide field having inhomogeneous magnetic field lines. This can be done with different set ups, shapes, and dimensions of the magnets and/or the extension yokes. The magnetic field can thus be adapted to the specific application.

It may also be advantageous to have an inhomogeneous wide field for sporting events. A couple of examples are: to create a type of barrier that has a very narrow, almost line-like capture range or a capture range that is very flat and vertically oriented, like the surface of a wall. With these types of detection fields, it is possible to very precisely determine the time an object crosses a goal line.

It may be advantageous that the markers have an individual identification, so that, when the set up uses multiple markers, the position of the object to be detected can be determined precisely. In this case, the sensor provided on an object and its electronic circuit generate a detection signal that is specific to that particular marker. Referring again to the hurdle race, it is not necessary that the individual markers have individual identifications, because, due to the way the course is set up, each individual detection signal is allocatable to a specific marker, even if the detections signals are all the same. On the other hand, in order to detect an object within a certain area, when this object moves along a course that is not pre-determined, for example, as described above with the horses in a stall, then having an individual identification for each marker makes it possible to be able to locate the object clearly within the area.

The barrier or gate previously mentioned that can be advantageously used may have a marker arrangement that includes at least two MCDs spaced apart at least several decimeters, and possibly, from one to two meters apart, so that these two MCDs form an invisible barrier or an invisible gate, that will reliably generate a detection signal, when the corresponding sensor is moved through this gate or barrier.

Advantageously, the sensor may be worn in a belt that is worn by a person or animal. For a person, the belt may be worn around the hips or waist, for example. Wearing the belt on the torso of the person or animal eliminates errors in the capture data when crossing a finish line, for example, that may occur when the sensor is worn on the extremities of the body, such as on the wrist, because, stretching the hand forward may result in a time for crossing the finish line that is earlier than the actual crossing.

The extension yoke may be formed differently than just a straight bar as mentioned above. Also, a different object may be used. The geometric shape can influence the magnetic field and is selected accordingly, so that the shape or object used contributes to an improvement in the intended alignment for the switching characteristics that result in triggering a sensor signal.

At least two MCDs are used to create the invisible barrier. In a practical system, these MCDs are set up at a distance of about one to two meters apart. The MCDs are placed vertically to the ground, that is, for example, aligned in a Z-axis of a coordinate system, in which the X and Y axes extend parallel to the ground and orthogonal to one another. The orientation of the MCDs may be selectively with the poles oriented the same or oppositely. In a set up in which the poles are oriented in the same direction, the same poles of both MCDs point downward, that is, North/North or South/South, and with opposite orientation, a different pole on each MCD points downward, that is, North/South or South/North.

In a different set up, the two MCDs are not set up vertically, but are oriented at an angle to the vertical. Depending on the angle, and how the angles of the two MCDs are between each other, variously shaped wide fields may be obtained and used for different purposes. In one set up, the two MCDs are angled approx. 30 degrees to each other. This can be advantageous, when the sensor passes the barrier at distinctly different heights from the ground. This is the case, for example, when children and adults are to be detected at the same time. Similarly, the two MCDs may be set up horizontally.

Setting up two markers in the sense of the mentioned invisible barrier results in an advantageous reciprocal influence of the two magnetic fields, so that wide fields may be generated, that indicate clear changes in intensity in a small area and, therefore, show an improved sensitivity to direction. In this way, it is possible to not only measure distance with precision, but also to obtain information as to from which direction the sensor, or the person wearing the sensor, is approaching the invisible barrier constructed with the marker or markers.

The maximum size of the overall field is limited to a relatively small area when the poles are oriented the same, and small changes in position in this field result in strong changes in the magnetic field.

When the sensor passes the barrier, a characteristic signal that is spatially high is triggered. In a set up in which the poles of the MCDs are oriented opposite each other, there is a very sharp minimum area between the magnetic fields, which also generates a very characteristic signal when the sensor passes the barrier. The magnetic fields have a direction and because of this, the sensor signal is different, depending on the direction from which the magnetic barrier is activated.

If the MCDs are set up inside so-called cones, such as are known as roadside markers, then the inside of the cone may be used at the same time for shielding the close range of the magnets. The cones enable an uncomplicated, quick set up and take down times for the markers. The MCDs may be provided in the form of sticks that are stuck into the cones, so that the cones are used solely to provide a secure stand and enable one to set up and take down the detection barrier without using tools. It's also possible to use common holders for slalom poles. The poles may also have a stake that is stuck directly into the ground.

Providing the MCDs in bar form also allows them to be mounted on existing infrastructures, such as on gate panels or frames or similar structures. Depending on the type of sporting event, the dipoles may be mounted on the hurdles or on the slalom poles, etc. It is understood, that, depending on the method of mounting the sensors, various strengths of magnets may be used to create the MCD, so that triggering the capture signal is reliably ensured, even at greater distances, for example, placing the magnets in the cones, or in belts that are worn by a rider.

Magneto-sensors that are typically used in electronic compasses may be used. In this application, the sensors detect the earth's magnetic field in all three spatial directions. Often, external disruptive fields cause a problem for the North/South recognition, which can influence the detection results. Complicated algorithms are used to eliminate errors caused by that. For application with the system according to the invention, the problem is the reverse: the earth's magnetic field is of no interest and the useful information is in the external magnetic field.

In a preferred embodiment, the sensors, including the necessary control and data storage unit, are placed in a belt worn on the body. The sensor is near the center of gravity of the body, near the spine.

In one embodiment, at least one MCD is used. Magnet sensors are used as the active sensors, such as are used in electronic compasses, for example. These sensors measure the magnetic field in at least one, preferably in three spatial direction, i.e, x, y, z directions. Using these permanent magnets, it is not a problem to place the markers with distances of 0.3 m to 0.5 m between them. Thus, it is possible to achieve distance-dependent switching operations. For example, a measurement is taken only then, when the distance exceeds or falls below a pre-determined distance or when the distance lies within a pre-determined range. This “active” range may be adjusted differently for different persons. For some applications, the active range is a large as possible. In this case, the decision is only “present” or “not present.” In other cases, detecting the distance is critical.

In another embodiment of the system according to the invention, the frequency of the rotation of the marker/sensor to each other over a wide distance is detected and measured.

A steep switching characteristic is required when time is to be measured in the range of milliseconds. For this reason, a magnetic barrier as previously described is used, one that has two MCDs. The chronological change of the field strength when the sensor is passing the barrier is evaluated. The exact switching time is determined by an algorithm that determined a characteristic measurement time point from the change in the measurement signal. For this, the passage through the barrier is determined in a first step by means of known methods of patter recognition. This method takes into consideration that the exact characteristic of the signal is variable and, among other things, depends on the type of magnetic barrier with regard to length, position, and set up of the two MCDs to each other, on how the sensor is mounted with regard to distance to the ground, and possible on disruptive fields in the surroundings. It is also important, to know whether passage through the barrier takes place in the center or close to one side of the magnetic barrier. Is the result “passage”, or “finish line crossed” recognized, the exact switching time is then determined by a one-step or multi-step method within a certain range around the found pattern. Characteristic points in the sensor data, such as, for example, extreme values, null passages, concentrations of partial areas, intersections of equalizing stretches or slopes or statistical values of such points, are suitable for this. Calculations in the frequency range by means of FFT or wavelet analysis can also be used to determine a characteristic point in time.

For the recognition and calculation processes, the sensor signal may be either processed directly or pre-processed, for example, with filter operations, summations, or derivations. Each spatial direction can be used alone or combinations of vectors, that are calculated from two or three spatial directions, may be used. The total vector from all three directions ideally does not change with movement within the earth's magnetic field, but only when approaching the MCDs. This method guarantees a robust and same shape recognition, in contrast to methods that are based on threshold values, for example.

Mounting the passive marker is not dependent upon a certain height, as is the case with light barriers. When measuring times for persons, the light barrier has to be mounted at the height of the lower torso. If the barrier is lower, that is, in the area of the legs, the times measured may be inaccurate. With the system according to the invention, however, the height of the marker is much less critical.

In another embodiment, an inertial measurement system is used as the sensor, such as, for example, are provided in many smart phones. An inertial system usually includes a combination of a three-axis accelerometer and a three-axis gyroscope and, additionally, a three-axis magneto-sensor. The magneto-sensor takes on the function of the sensor.

In another embodiment, the inertial system contributes significantly to suppressing disruptive fields. The earth magnetic field has a known strength, whereas the signal used in the wide field has a different strength. Disruptive fields caused by electrical devices, iron parts, concrete reinforcements, etc., often lie on the order of size of the signal used or above it. The information from the inertial system is used as a filter, to prevent false signals. Thus, based on acceleration data, for example, it is possible to ascertain whether, at a specific time, the runner is moving and in which direction. Signals generated at the magnetic barrier outside of the time frame of motion can be ignored. The gyroscopes of the inertial system indicate, whether the system is turning or not.

Changes in the magnetic field in the corresponding axes without rotation information from the gyroscope can be recognized as disruptive fields. The trajectory calculation, i.e., position and change in position in three-dimensional space, based on the inertial data can help in further limiting the time window in which the barrier is within range, so that signals outside the time window can be ignored.

The measurement data of the magnetic barriers can also be compared with and combined with step data. An external step counter may be used, one that is synchronized with the magneto data. In another embodiment, the steps can be recognized based on one or more measurement or data channels of the inertial system.

Similarly, instead of the step data, the trajectory calculated from the inertial data may be used. The trajectories have the disadvantage, that they reflect well the change in motion, but that the absolute position becomes ever more imprecise because of cumulative small errors. By measuring various distances with the magnetic barrier function, these relative movements can be reconciled with the measured marker positions. In this way, it is possible to give not only the average speed between the markers, but also to determine with high accuracy the trajectory between the points of measurement. In a similar application, the marker recognition can be used to subdivide any measurement with regard to time/space and, thus, to identify the interesting places in the overall measurement.

In another embodiment, the trajectory is determined within a magnetic wide field. When calculating the location and position of the sensor system, the known formation of field lines can be taken into consideration and, thus, the precision significantly increased.

In order to be independent of other influences, the field strength can be measured with more than one spatially offset marker. The relationship of these field strengths to one another allows a precise switching point to be determined.

Various methods may be used to differentiate various markers from one another. In one method, the absolute field strength serves to differentiate the markers. There are a total of six different set up possibilities of the two MCDs in the magnetic barriers. There are three possibilities for the location relative each other, namely, vertical, horizontal in parallel and horizontal in a line. There are two set ups, either with poles oriented in the same direction or in opposite directions. These are the set up possibilities that determine the different spatial formations of the magnet field lines.

By using different types and shapes of the extension yoke, the magnetic field can be formed to be wider or narrower, for example. Several fields may be switched in series, for example, by setting up two barriers very close behind each other at a gate, by setting up three barriers at another gate, etc. This makes it possible, to determine field strength formations relative one another. Thus, the switching time point, for example, or the identity of the marker may be determined independently of the absolute field strengths and, thus, independently of external influences, such as, for example, the ambient temperature.

The marker/sensor system can be used for navigation. For this purpose, specific places are spatially subdivided by one or several markers. For example, areas can be defined, that are to be entered or not entered. Upon entry in such an area, a signal is generated and sent to the user. This can be used, to keep the user or a device away from a certain area or to direct user or device into a certain area.

In another application the different places are differentiated by passageways that are marked with a magnetic barrier. When passing the correct or incorrect barrier, the appropriate signal is generated in the belt, as feedback for the user.

As described above, an MCD comprises several individual components that have to have a certain spatial arrangement relative each other. If components of this arrangement are movable, then the magnetic properties of the compound dipole is changed in wide ranges and thus modulated. If these movable components are connected with a door, a window, a physical barrier, a swimmer, etc., then the position of these components has an effect on the measurement and thus can be registered. The advantage of such an arrangement lies in the fact that such a system does not require an additional power source.

In one embodiment a rotatable disk is positioned between two fixedly positioned magnets. This disk has a different magnetic permeability, depending on the direction of rotation. In the simplest case, a radially extending yoke is provided on the disk. If the disk is rotated, so that the yoke is located between the two magnets, then an MCD is created, but not at any other arrangement of the yoke. A similar effect can also be triggered, when the MCD is influenced by a second, movable MCD or magnet, or turned around.

In another embodiment, the modulating acting MCD /magnet is mounted on a fitness device. The primary MCD/sensor system is used to detect the present of the athlete on the fitness device. The modulating acting MCD/magnets detect the execution and number of executed exercises. In another application, the magnetic barrier is used to measure the time of an exercise on the fitness device. The modulating MCD/magnet codes the force required to do it. In another embodiment, the modulating MCD/magnet may also be affixed to another person. In this case, it is possible to recognize the different positions of persons relative each other.

In another application, the orientation characteristic of the system is used to determine the angle of view of a test person. The advantage lies in the fact that the test person only has to wear or carry the passive marker, without power supple and data transmission. The active components are located, in this case, for example, in a device, for example, a 3D television.

The formation and strength of the field lines may also be generated by an electro-magnet or modulated. In the first case, the electro-magnet takes on the function of the permanent magnet, in the latter case, the electro-magnet modulates the field of the permanent magnet. Thus, the properties of the magnetic barrier may be changed in a wide range with regard to range, recognition security, identity, etc. In an embodiment, the system can be so adjusted that it only reacts to certain, for example, changing magnetic fields or additional information may be modulated.

### BRIEF DESCRIPTION OF THE DRAWINGS

Embodiments of the invention are now described in greater detail, with reference to the purely schematic figures.

FIG. 1 shows a first embodiment, in which two magnetic compound dipoles (MCD) form a barrier.

FIG. 2 illustrates a set up with an MCD in a cone, such as can be used in the embodiment of FIG. 1.

FIG. 3 shows an embodiment in which an MCD is provided on a first fitness device.

FIG. 4 shows an embodiment of the invention, in which an MCD is provided in a second type of fitness device, without the use of a barrier.

FIG. 5 is a rear view of the MCD of FIG. 4.

FIG. 6 s a modified embodiment of the one shown in FIG. 4.

FIG. 7 shows a first embodiment of an MCD.

FIG. 8 is a partial illustration of a second embodiment of an MCD.

FIG. 9 shows an MCD provided with a sheath.

FIG. 10 shows a first embodiment of a magnetic barrier that uses an MCD.

FIG. 11 shows a second embodiment of a magnetic barrier that uses an MCD.

FIG. 12 shows a third embodiment of a magnetic barrier that uses an MCD.

FIG. 13 shows a fourth embodiment of a magnetic barrier that uses an MCD.

FIG. 14 shows a fifth embodiment of a magnetic barrier that uses an MCD.

FIG. 15 shows a sixth embodiment of a magnetic barrier that uses an MCD.

FIG. 16 illustrates a magnetic barrier for a horseback riding event.

FIG. 17 illustrates a magnetic barrier for a ball sporting event, together with the corresponding ball.

FIG. 18 illustrates the run of magnetic field lines with a first embodiment of a magnetic barrier.

FIG. 19 illustrates the run of magnetic field lines with a second embodiment of a magnetic barrier.

### DETAILED DESCRIPTION OF THE INVENTION

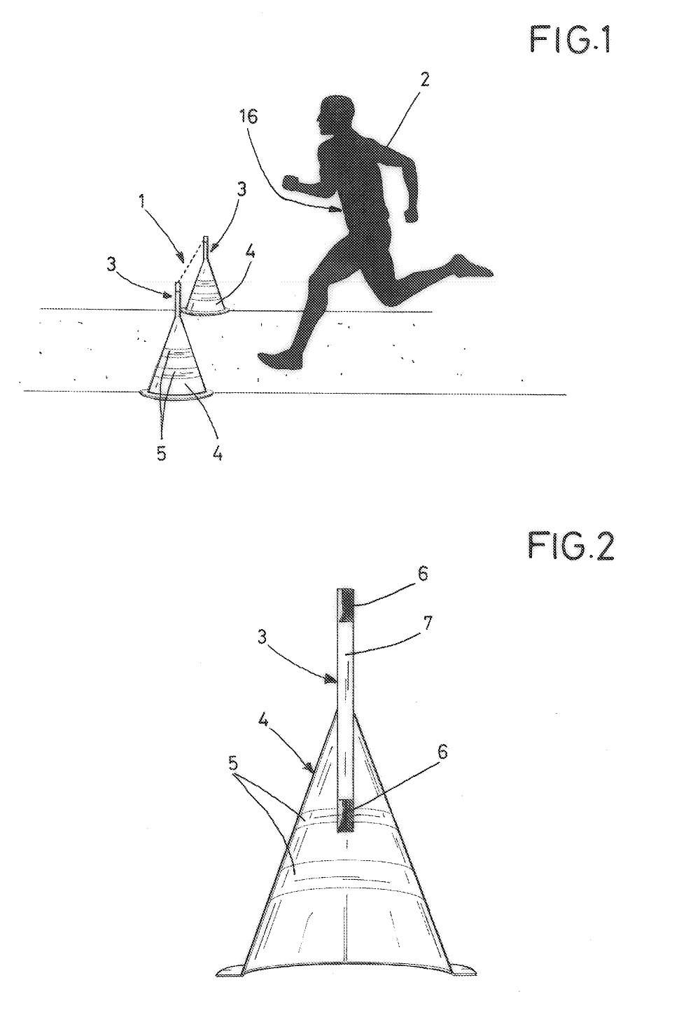

FIG. 1 illustrates an athlete 2 moving toward an invisible barrier 1: The athlete wears a belt with a sensor 16 The barrier, shown with dashed lines, is set up as a spatially fixed device and is formed by two markers. Each of the two markers is constructed as a magnetic compound dipole (MCD) 3 and mounted on so-called cones 4, i.e., on pylons, such as are used, for example, in traffic control. In this manner, a type of gate is created, through which the athlete 2 is to run and which the athlete can easily recognized, because the cones 4 have contrasting color stripes 5. With this set up, multiple barriers 1 may be set up at a venue that is not at a sports arenas, for example, for sporting events in which a number of athletes 2 are to be guided through the center of a city or through other courses.

The barrier 1 is an imagined, invisible line between two posts of the virtual gate through which the athlete 2 is to run, whereby the construction of the post is clearly shown in FIG. 2: The cone 4 and the MCD 3 that is integrated into the cone 4 form the virtual gate.

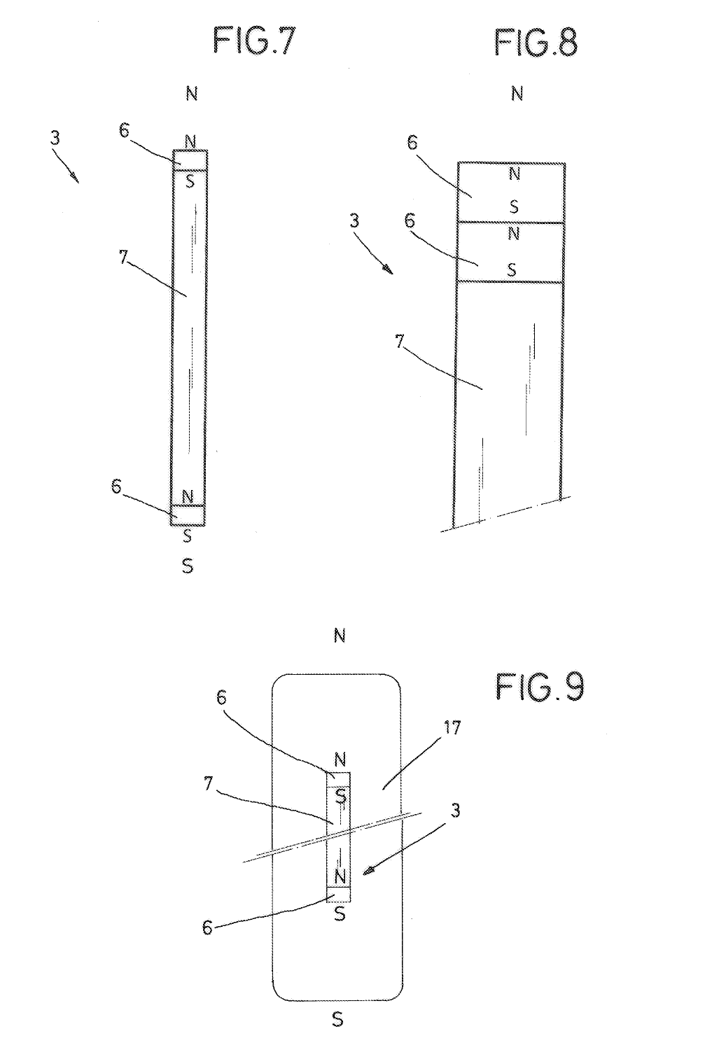

FIG. 7 illustrates the MCD 3 as having two magnets 6 arranged at the ends of a metallic extension yoke 7. FIG. 8 illustrates that two or more magnets 6 are provided on each end of the MCD 3. The MCD 3 is removably mounted in the cone 4, whereby the cone 4, for example, may have a sleeve that is open at the top, so that the MCD 3 is insertable through this opening, or the MCD 3 may have a circumferential flange on the extension yoke 7, which limits the insertion depth into the cone 4. In any case, multiple cones 4 are stackable, one on top of the other, after the MCDs have been removed. The MCDs 3 may also be bundled together to save space, so that overall, the organizational effort that is involved in setting up and later taking down a number of barriers 1 for a sporting event is reduced. The time detection barriers take up a relatively small space when being transported and may be set up in a very easy manner. This is because there is no need for cables, electronics for data evaluation, etc. to set up and operate the barriers 1, such as is necessary when the barriers have to be permanently installed along a race course.

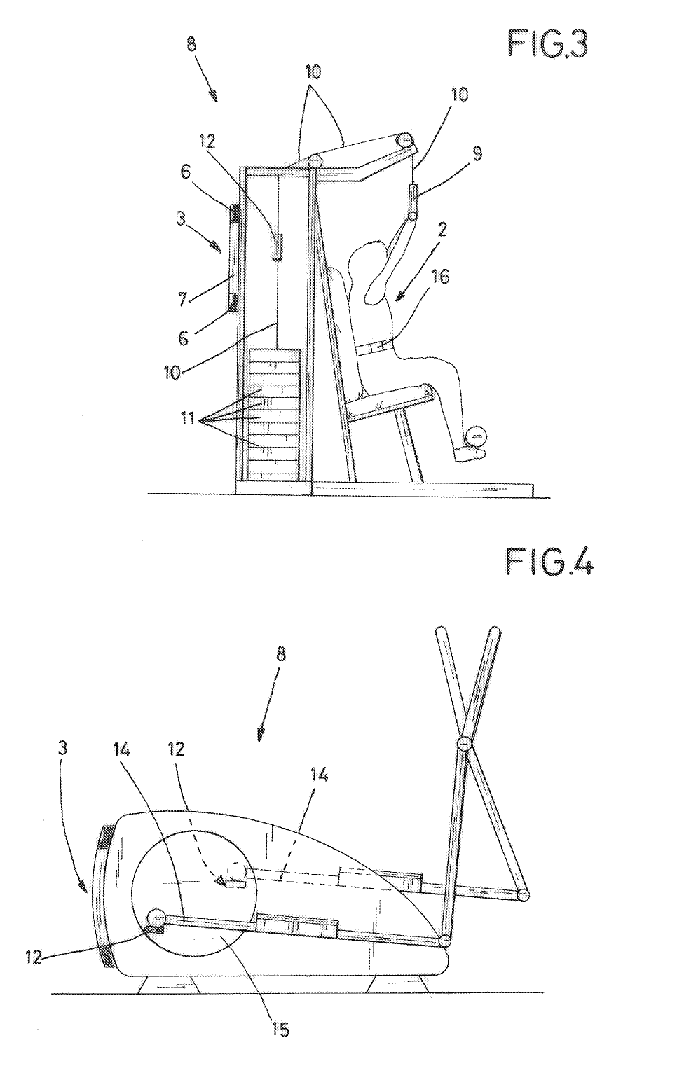

FIG. 3 shows a fitness device 8, that has a bar 9 that is operated by the athlete 2. The athlete 2 wears a belt with a sensor 16. The bar 9 is connected with a plurality of weights 11 via a cable 10 guided over several pulleys. The cable 10 carries not only the weights 11, but also a magnet 12, that is movable along with the cable 10 and, particularly, is movable relative a spatially fixed mounted MCD 3. The presence of the athlete 2, as well as also the number of motions that the athlete carries out with the bar, are recorded by sensor based on the modulation of the magnetic field on the MCD 3. This is done without requiring the use of a barrier 1 with the system that is shown here in FIG. 3. A second MCD 3 may be used to modulate the magnetic field of the first MCD 3.

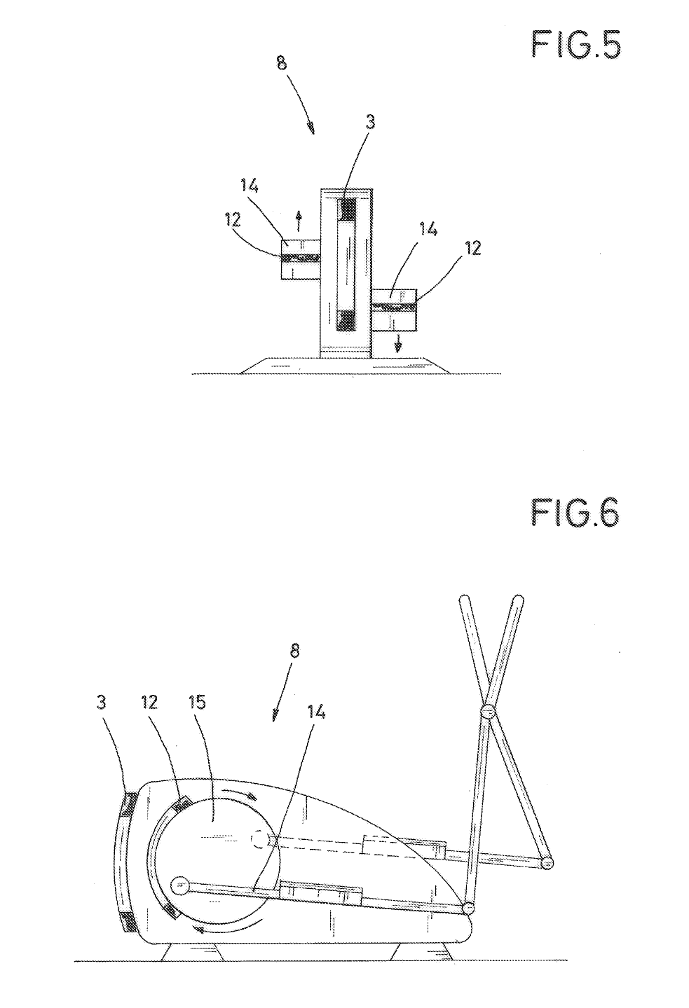

FIGS. 4 to 6 illustrate a system for recording the position of an object in which a barrier 1 is not needed. The fitness device 8 shown here is a so-called ellipsis trainer, shown in side view in FIGS. 4 and 6. FIG. 5 illustrates components of the trainer 8 seen from the rear. Similarly to the set up shown in FIG. 3, the athlete 2 wears a belt here, too, with the sensor 16, and a movable magnet 12 is mounted on the fitness device 8, where the spatially fixed MCD 3 is also mounted. The system according to the invention records the number of motion cycles that the athlete 2 executes with the fitness device 8, based on the relative motion between the MCD 3 and the magnet 12.

FIGS. 4 and 5 show, in two different variants of the ellipsis trainer, that the movably mounted magnet 12 may be provided on one of the two step platforms 14 on which the athlete stands, or that a movable magnet 12 may be mounted on each of the step platforms 14. Or, it is also possible, as shown in FIG. 6, to affix the movable magnet 12 to a flywheel or cam wheel 15 that is set into rotation by means of the step platform 14 that serves as a crank to rotate the cam wheel. Instead of a magnet 12, a second, movable MCD 3 may be used. Also, instead of the sensor 16 that is worn by the athlete 2, the sensor may also be set up a distance from the fitness device 8.

FIG. 9 illustrates an MCD 3, that is encased in a sheath 17. The sheath 17 does not have to be constructed as a magnetic shield, but merely serves to maintain a minimum distance of the MCD 3 to the surrounding objects, so as to reliably avoid magnetic disturbances that can be generated in close range to the MCD 3 because of the relatively strong magnetic field. Furthermore, the sheath 17 may be constructed as protection against the elements of the weather, for example, so that the material used for the extension yoke 7 is protected against corrosion. Finally, the sheath 17 may also be padded, to serve as a mechanical protection for the MCD 3 as well as for the athletes 2, when they run through a magnetic barrier 1.

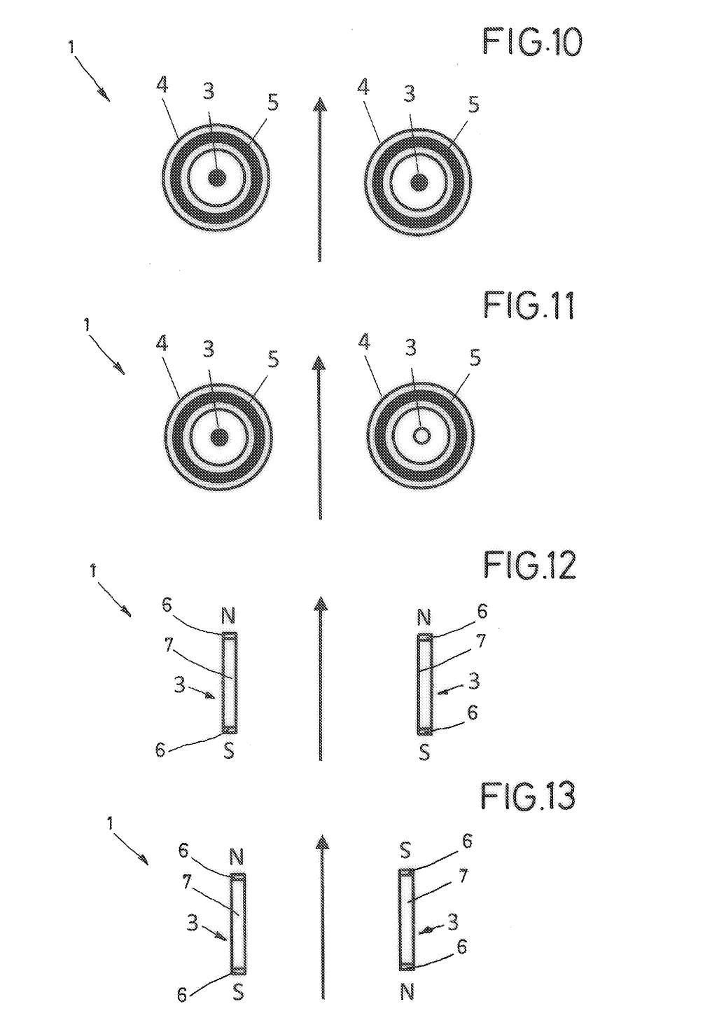

FIGS. 10 to 15 illustrate six different embodiments of magnetic barriers 1, whereby these illustrations all show the magnetic barrier in a plan view. The arrow indicates the direction in which the athlete 2 passes through the barrier 1. Different set ups enable the recognition of the individual barriers, because the change in the magnetic field when passing the sensor differs in the set ups. Additional combinations of set ups are possible with the use of diagonally oriented MCDs.

FIG. 10 is a plan view of a magnetic barrier 1, by which the two cones 3 are provided with contrasting stripes 5 and each has a vertically oriented MCD 3. Both MCDs 3 are oriented in the same direction, i.e., with either both north poles or both south poles of the magnets 6 pointing up.

FIG. 11 illustrates a magnetic barrier 1, that has the same basic construction, whereby the two MCDs 3 are oriented differently in the cones 4. In other words, in one MCD, the north pole of the magnets 6 is pointing up and in the other MCD in the cone 4 the north pole of the magnet 6 used there is pointing down.

FIGS. 12 and 13 illustrate two magnetic barriers 1, in which the MCDs 3 are oriented horizontally, also, lying down, and parallel to the direction the athlete is running through the gate. The “N” and “S” indicators make clear, that, in FIG. 12, the MCDs 3 are oriented the same, whereas the two MCDs 3 in the magnetic barrier in FIG. 13 are oriented opposite each other.

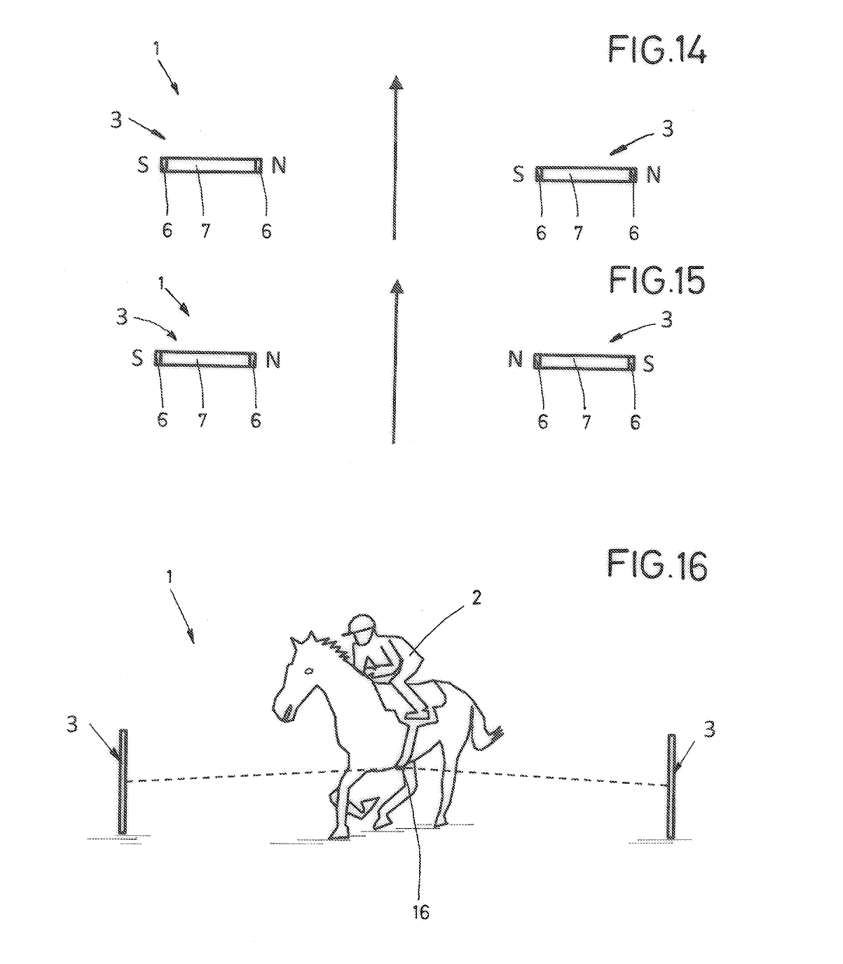

FIGS. 14 and 15 show two constructions of magnetic barriers 1, in which the MCDs 3 are also horizontally oriented, but not in the direction the athlete is running, but rather, transverse to the runner's direction. FIG. 14 relates to an embodiment, in which the two MCDs 3 are oriented in the same direction, and FIG. 15 to an embodiment of the magnetic barrier 1 in which the MCDs are oriented opposite each other. In these two embodiments, the two north poles of the MCDs 3 point inward, i.e., toward the athlete 2 or toward the open passage through the magnetic barrier 1.

FIG. 16 shows an athlete 2 riding a horse through the open passage way of a magnetic barrier 1. The two MCDs 3 are arranged in vertical orientation and, in this embodiment, the athlete 2 is not wearing a belt, but rather, the belt is part of the saddle belt that the horse is wearing. The sensor 16 is arranged in the lower area of the saddle belt. The dashed lines show how the lines of the sensor 16 run to the MCDs 3 of the magnetic barrier 1 and indicate schematically the action between the sensor 16 and the MCDs 3.

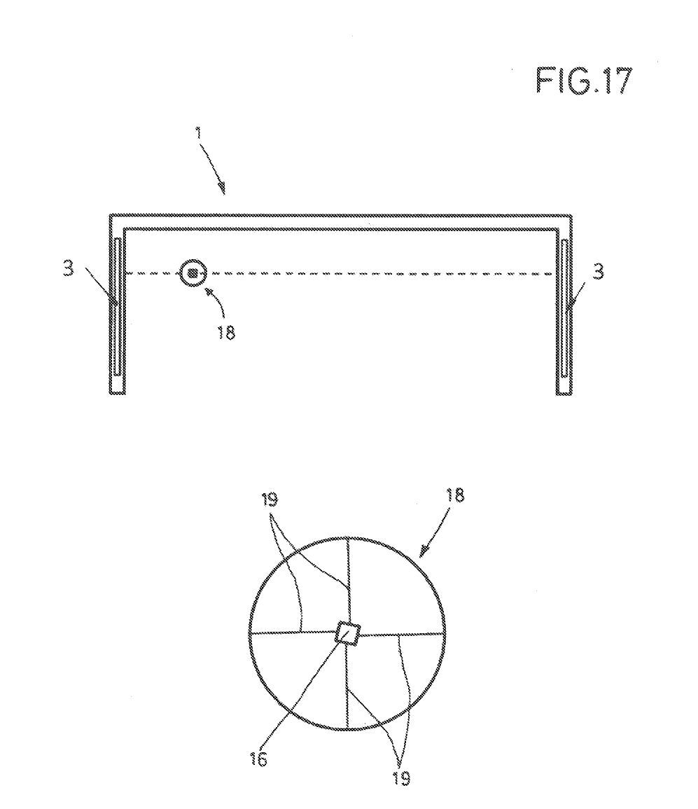

FIG. 17 shows that the magnetic barrier 1 is not used to detect an athlete's travel, but rather, travel a ball 18. The two MCDs 3 are mounted on the goal posts of a soccer goal. Depending on the material that the goal posts are made of, the MCDs 3 may be embedded into the posts. The ball 18 just crossing the goal line in the upper portion of FIG. 17 and, thus, the magnetic barrier between the two MCDs 3. The effective lines between the sensor 16 that is incorporated into the ball 18 and the MCDs 3 are shown in dashed lines.

The ball 18, which is shown in a larger scale in FIG. 17, below the soccer goal, carries the sensor 16 inside it. The sensor 16 is elastically suspended in the center of the ball 18 to protect it. The sensor 16 may be read wirelessly via a data cable after the end of the game. It is a particular advantage, however, if the sensor 16 is equipped with a radio module, so that during the game, practically in real time, the sensor signal may be evaluated. This provides irrefutable evidence, for example, of whether the ball 18 crossed the goal line between the soccer goal posts.

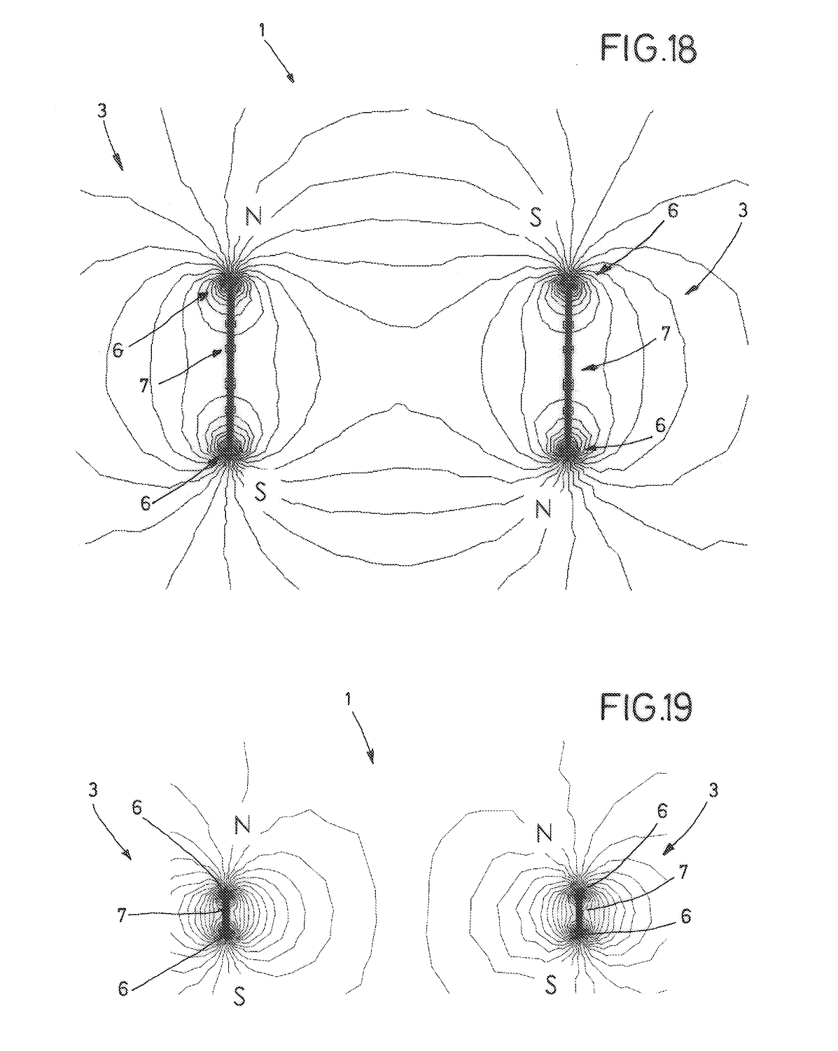

FIG. 18 shows the magnetic field lines of two MCDs 3, which are oriented opposite each other, as can be seen on the “N” and “S” designations on the magnetic north and south poles.

FIG. 19 shows, with the same distance of the two MCDs 3, that is, with a magnetic barrier 1 having the same width, the magnetic field lines of an arrangement in which the magnets 6 of the MCDs 3 are oriented in the same direction.

What is claimed is:

1-9. (canceled)

10. A system for capturing the position of a movable object, the system comprising:
a marker that is a passive component, the marker constructed as a magnetic dipole compound (MCD) having an extension yoke that is a bar made of ferromagnetic material and with a magnet placed at each end of the extension yoke, the two magnets oriented with the north pole pointing in the same direction;
a sensor that is an active component having a power supply and an electronic circuit, the sensor having a detection distance for detecting motion and being mounted on or carried by the object, the electronic circuit including a clock means and data storage; and
wherein, the marker is spatially fixed and, when the sensor is a distance from the marker that is a smaller distance than the detection distance of the sensor, the presence of the marker is automatically detected by the sensor, a signal generated, and the time of signal generation automatically stored.

11. The system of claim 10, wherein the object includes a plurality of objects and the sensor includes a plurality of sensors, each sensor of the plurality of sensors being provided on a different object.

12. The system of claim 10, wherein the marker includes a plurality of markers, each of the markers being spaced apart from other markers so as to create an area with multiple detection areas.

13. The system of claim 12, wherein each one of the plurality of markers has a unique identifications and wherein the electronic circuit of the sensor generates a detection signal that is typical for each unique marker.

14. The system of claim 10, wherein the extension yoke has a length of greater than 10 cm.

15. The system of claim 10, wherein the marker includes two markers arranged a distance apart of several decimeters to form a barrier that is invisible and that extends between the two markers.

16. The system of claim 10, wherein the sensor is incorporated into a belt that is worn on the body of the object.

17. The system of claim 10, further comprising a magnet for modulation of a magnetic field of the marker, wherein the magnet is movable relative the marker and the magnetic field of the MCD in the marker is arranged to detect modulation.

18. The system of claim 15, further comprising a magnet for modulation of a magnetic field, wherein the magnet is movable relative the barrier and the barrier is arranged to detect modulation.

19. The system of claim 10, wherein the marker includes an additional MCD that is movable relative the marker and modulates the magnetic field of the MCD in the marker and wherein marker is arranged to detect modulation.
